(19) United States
(12) Patent Application Publication
(10) Pub. No.: US 2008/0095697 A1
(43) Pub. Date: Apr. 24, 2008

(54) PRODUCING METHOD FOR METAL OXIDE COMPOSITE PARTICLE, METAL OXIDE COMPOSITE PARTICLE, AND FRICTION MATERIAL

(76) Inventors: Yoshihiro AOYAGI, Tokyo (JP); Hiroshi Idei, Tokyo (JP); Shou Kurihara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/873,607

(22) Filed: Oct. 17, 2007

(30) Foreign Application Priority Data
Oct. 19, 2006 (JP) P.2006-285374

(51) Int. Cl. C01B 13/14; C07F 5/06; C07F 7/02; C07F 7/28

(52) U.S. Cl. 423/592.1; 556/181; 556/482; 556/51

(57) ABSTRACT

A metal oxide composite particle is produced by hydrolyzing and condensing a hydrolysable metal compound in a solvent and in the presence of an inorganic particle and/or an organic particle to form a metal oxide sol, and subjecting the obtained sol to drying, heating and crushing processes.

This application claims foreign priority from Japanese Patent Application No. 2006-285374 filed on Oct. 19, 2006, the entire contents of which are hereby incorporated by reference.

### BACKGROUND OF THE INVENTION

1. Field of the Invention

The present invention relates to a producing method for a metal oxide composite particle, a metal oxide composite particle and a friction material. More particularly, the present invention relates to a producing method for a metal oxide composite particle, adapted for use for example as a constituent of a frictional material, a metal oxide composite particle obtained by such method, and a friction material containing the metal oxide composite particle.

2. Related Art

A friction material, utilized in a brake pad or a brake lining of various vehicles and industrial machinery, includes a fibrous material such as heat-resistant organic fiber, inorganic fibers or metal fibers, an inorganic/organic filler, a friction modifier and a binder as a matrix material.

The friction material is obtained by mixing the aforementioned materials in a powdered state, then molding (pre-molding) the mixture under a predetermined pressure at the normal temperature, and executing a thermal molding at a predetermined temperature, followed by a curing process (after-cure) and a finishing process.

In the producing process of the friction material, the materials are desirably present in a uniform distribution, and have therefore to be mixed uniformly. However, a segregation may occur in the obtained friction material, resulting from the differences in the characteristics derived from materials, such as a particle size, a particle size distribution, a density, a shape and an adhesivity thereof.

### SUMMARY OF THE INVENTION

One or more embodiments of the invention provide a producing method of a metal oxide composite particle, capable of being dispersed uniformly. Further, one or more embodiments of the invention provide a metal oxide composite particle obtained by the method. In addition, one or more embodiments of the invention provide a friction material containing the metal oxide composite particle.

(1) In accordance with one or more embodiments of the invention, a producing method of a metal oxide composite particle is provided with: forming a metal oxide sol by hydrolyzing and condensing a hydrolysable metal compound in a solvent and in a presence of an inorganic particle and/or an organic particle, and drying, heating and crushing the metal oxide sol.

(2) In the producing method of (1), the inorganic particle may comprise at least a material selected from barium sulfate, calcium carbonate, montmorillonite, mica, vermiculite, graphite, molybdenum disulfide, zirconia, alumina, silica, magnesium oxide, iron oxide, copper, aluminum, zinc, brass, and cast iron.

(3) In the producing method of (1) or (2), the organic particle may comprise at least a material selected from phenolic resin, polyimide resin, polybenzoxazine resin, epoxy resin, aramide resin, fluorine-containing resin, rubber powder, and cashew powder.

(4) In the producing method of one of (1) to (3), the hydrolysable metal compound may comprise a metal alkoxide.

(5) In the producing method of (4), a metal constituting the metal alkoxide may comprise at least one selected from Al, Si, Ti and Zr.

(6) In the producing method of (4) or (5), the metal alkoxide may be represented by a formula (I):
M(OR)ₙ (I)
and, M represents Al, Si, Ti or Zr; R represents an alkyl group having 1 to 6 carbon atoms; and n is a valence number of M and represents 3 or 4.
(7) In the producing method of one of (1) to (6), an acidic catalyst or a basic catalyst may be used at the hydrolysis and condensation of the hydrolysable metal compound for forming the metal oxide sol.
(8) In the producing method of one of (1) to (7), the drying may be executed by drying in vacuum.
(9) In the producing method of one of (1) to (8), the heating may be executed within a temperature range of from 200 to 1000° C.
(10) In the producing method of one of (1) to (9), the metal oxide composite particles may have an average particle size of from 5 μm to 5 mm.
(11) In accordance with one or more embodiments of the invention, a metal oxide composite particle may be produced by the method of one of (1) to (10).
(12) In accordance with one or more embodiments of the invention, a friction material may provided with the metal oxide composite particle of (11).

One or more embodiments of the invention provide a producing method for a metal oxide composite particle that is less liable to cause a segregation or the like in a matrix material and that can be dispersed uniformly, a metal oxide composite particle obtained by such method, and a friction material containing such metal oxide composite particle.

Other aspects and advantages of the invention will be apparent from the following description and the appended claims.

### DETAILED DESCRIPTION OF THE EXEMPLARY EMBODIMENTS

As an exemplary embodiments of the invention, a producing method of a metal oxide composite particle will be described.

In the producing method of a metal oxide composite particle, a metal oxide sol is formed by hydrolyzing and condensing a hydrolysable metal compound in a solvent and in the presence of an inorganic particle and/or an organic particle, and the obtained sol is subjected to drying, heating and crushing processes.

The solvent is not particularly restricted, and examples thereof include a polar solvent such as an alcohol type, a cellosolve type, a ketone type, or a ether type, and a mixture thereof with a non-polar solvent such as an aliphatic, alicyclic or aromatic hydrocarbon.

An inorganic substance constituting the inorganic particle is not particularly restricted, and examples thereof include at least a material selected from barium sulfate, calcium carbonate, montmorillonite, mica, vermiculite, graphite, molybdenum disulfide, zirconia, alumina, silica, magnesium oxide, iron oxide, copper, aluminum, zinc, brass, and cast iron. In the present specification, as described above, a metal such as copper, aluminum, zinc, brass or cast iron is also included in the inorganic substance constituting the inorganic particle.

Also the organic substance constituting the inorganic particle is not particularly restricted, and examples thereof include at least a material selected from phenolic resin, polyimide resin, polybenzoxazine resin, epoxy resin, aramide resin, fluorine-containing resin, rubber powder, and cashew powder.

The inorganic particle and/or the organic particle preferably has an average particle size of from 100 nm to 1 mm, more preferably from 1 μm to 500 μm. In the present specification, the average particle size means a volume-average particle size, which can be measured for example by a particle size distribution measuring instrument.

Also in the exemplary embodiment, a fibrous substance may be employed together with the inorganic particle and/or the organic particle.

The fibrous substance is not particularly restricted, and may be either of organic fibers and inorganic fibers.

Examples of the organic fiber include an aromatic polyamide fiber of a high strength (aramide fiber; such as “Kevlar” manufactured by DuPont), a flame-resistant acrylic fiber, a polyimide fiber, a polyacrylate fiber and a polyester fiber.

On the other hand, examples of the inorganic fiber include mineral fibers such as wollastonite, sepiolite, attapulgite, halloysite, mordenite, and rock wool; inorganic whiskers such as potassium titanate whisker and silicon carbide whisker; ceramic fibers such as glass fiber, carbon fiber and alumina-silica type fiber; and metal fibers such as aluminum fiber, stainless steel fiber, copper fiber, brass fiber and nickel fiber.

Such fibrous substance may be contained in one kind or in two or more types. In consideration of a bonding property in the obtained metal oxide composite particle, the fibrous substance is preferably an inorganic fiber. The fibrous substance preferably has an average diameter of from 0.1 to 100 μm, and more preferably from 1 to 15 μm. Also an average length is preferably from 0.3 to 500 μm, more preferably from 0.5 to 200 μm.

In the exemplary embodiment, in the presence of the inorganic particle and/or the organic particle described above, a hydrolysable metal compound is hydrolyzed and condensed to form a metal oxide sol.

The hydrolysable metal compound is not particularly restricted so far as it can be hydrolyzed and condensed to form a metal oxide sol, but a metal alkoxide is preferred in consideration of a hydrolyzing property and availability.

Examples of the metal alkoxide include those in which a metal constituting the metal alkoxide is at least one selected from Al, Si, Ti, Zr, an alkali earth metal and a rare earth metal, but, in consideration of a stable reactivity in the hydrolysis and condensation and the performance of the obtained metal oxide composite particle, particularly preferred are those in which the metal constituting the metal alkoxide is at least one selected from Al, Si, Ti and Zr.

Examples of such metal alkoxide include those represented by a general formula (I):
M(OR)ₙ (I)
wherein M represents Al, Si, Ti or Zr; R represents an alkyl group having 1 to 6 carbon atoms; and n is a valence number of X and represents 3 or 4.

In the general formula (I), M represents Al, Si, Ti or Zr and n is a valence number of M, and n is 3 in the case that M is Al, or is 4 in the case that M is Si, Ti or Zr. Also the alkyl group having 1 to 6 carbon atoms, represented by R, may be linear, branched or cyclic, and examples thereof include a methyl group, an ethyl group, an n-propyl group, an isopropyl group, an n-butyl group, an isobutyl group, a sec-butyl group, a tert-butyl group, a pentyl group, a hexyl group, a cyclopentyl group and a cyclohexyl group.

Examples of the metal alkoxide when M is trivalent Al include trimethoxy aluminum, triethoxy aluminum, tri-n-propoxy aluminum, triisopropoxy aluminum, tri-n-butoxy aluminum, triisobutoxy aluminum, tri-sec-butoxy aluminum and tri-tert-butoxy aluminum.

Also examples of the metal alkoxide when M is tetravalent Si, Ti or Zr include tetramethoxysilane, tetraethoxysilane, tetra-n-propoxysilane, tetraisopropoxysilane, tetra-n-butoxysilane, tetraisobutoxysilane, tetra-sec-butoxysilane, tetra-tert-butoxysilane, phenyltriethoxysilane, aminotriethoxysilane, and compounds in which silane of the foregoing silane compounds is replaced by titanium or zirconium. Also as a silicon alkoxide, also usable are oligomers of tetraalkoxysilane such as “Methyl Silicate 51”, “Ethyl Silicate 40” (trade names of Colcoat Co.), “MS-51” and “MS-56” (trade names of Mitsubishi Chemical Co.).

The hydrolysable metal compound is added in a predetermined proportion, in a solvent, together with the inorganic particle and/or the organic particle and with the fibrous substance in certain cases, and uniformly dispersed under sufficient agitation.

Then water of an amount necessary and sufficient for the hydrolysis of the hydrolysable metal compound is added to the dispersion. Also an acidic catalyst such as hydrochloric acid, sulfuric acid, nitric acid, formic acid or acetic acid, or a basic catalyst such as ammonia water, sodium hydroxide or potassium hydroxide, is added according to the necessity, and a hydrolyzing and condensing reaction is executed at a temperature normally of from 0 to 80° C., preferably from 30 to 70° C. to form a metal oxide sol.

Then the metal oxide sol obtained in the foregoing step is subjected to a drying process to remove unnecessary solvent and water, thereby forming a dry gel. The drying method is not particularly restricted and may be drying under a normal pressure or drying in vacuum, but drying in vacuum is particular preferable.

The dry gel obtained in the foregoing step is subjected to a heating process to form a heated gel. The heating process is preferably executed by maintaining it at a temperature preferably of about from 200 to 1000° C., more preferably about from 300 to 600° C.

The heated gel obtained in the foregoing process is subjected to a crushing process to obtain a metal oxide composite particle, but the metal oxide composite particle may also be obtained by subjecting the dry gel to a crushing process in advance, and subjecting the crushed gel to a heating process in a similar manner as described above.

The method of crushing process is not particularly restricted, and various already known methods may be employed for this purpose. For example, employable is a method of utilizing a crushing machine of air flow type or impact type. In such operation, unnecessary fine and coarse particles may be removed an already known classifying method.

Thus obtained metal oxide composite particles preferably have an average particle size of from 5 μm to 5 mm, more preferably from 10 μm to 2 mm. The average particle size can be measured by a sieving method or by a method of utilizing a laser diffraction particle size distribution meter.

In the following, the metal oxide composite particle of the present invention will be explained.

The metal oxide composite particle is characterized in being obtained by the producing method for a metal oxide composite particle of the present invention.

As regards the metal oxide composite particle, the producing method, the constituent materials, the proportions of the constituent materials and the average particle size are same as described above.

Now the friction material of the exemplary embodiments will be explained.

The friction material of the exemplary embodiments include the metal oxide composite particle of the invention, and preferably further includes a matrix material.

Examples of the matrix material include a powder of a plastic material such as a thermoplastic resin or a thermosetting resin, and of a rubber material, and a powder of a plastic material is more preferable.

The thermoplastic resin mentioned above is not particularly restricted, and may be arbitrarily selected from those that have been utilized in a fiber-reinforced composite material. Examples of such thermoplastic resin include a polyolefin-type resin, a povinyl chloride-type resin, a polyamide-type resin, a polyester-type resin, a polyacetal-type resin, a polycarbonate-type resin, an aromatic polyether- or polythioether-type resin, an aromatic polyester-type resin, a polysulfone-type resin, a styrene-type resin and an acrylate-type resin.

The thermosetting resin mentioned above is also not particularly restricted, and may be arbitrarily selected from those that have been utilized in a fiber-reinforced composite material. Examples of such thermosetting resin include a phenolic resin, various denatured phenolic resins, a melamine resin, an epoxy resin, a polybenzoxazine resin and a polyimide resin.

Also the rubber material is not particularly restricted, and examples thereof include various natural and synthetic rubbers.

The friction material of the present invention preferably contains, with respect to 100 parts by mass of a matrix powder of the plastic material or the rubber material described above, the metal oxide composite particles of the present invention in a proportion of from 200 to 1200 parts by mass, more preferably in a proportion of from 400 to 1000 parts by mass.

The friction material of the exemplary embodiment may further include, in addition to the metal oxide composite particle and the matrix material, various additive components such as an inorganic/organic filler, a friction modifier, and a fibrous substance.

Examples of the inorganic filler include barium sulfate, calcium carbonate and antimony oxide, and examples of the organic filler include various resins and a cashew powder. Examples of the friction modifier include a lubricant such as graphite or molybdenum disulfide; a metal such as iron, copper or aluminum; and a metal oxide such as alumina, silica, magnesia, zirconia and chromium oxide. Also examples of the fibrous substance include an organic fiber such as an aromatic polyamide fiber, a flame-resistant acrylic fiber or a polyimide fiber; an inorganic whisker such as a potassium titanate whisker, or a silicon carbide whisker; and an inorganic fiber such as a glass fiber or a carbon fiber.

The friction material of the exemplary embodiments is not particularly restricted in the producing method therefor, and may be obtained, for example, by dry blending the metal oxide composite particles of the invention, the matrix material and various additive components, to be employed when necessitated, in an ordinary blender such as a Henschel mixer or a tumbler blender, then executing a molding at the normal temperature (pre-molding) under a predetermined pressure, and executing a thermal molding at a predetermined temperature, followed by a curing process (after-cure) and a finishing process.

### EXAMPLES

In the following, the present invention will be further clarified by examples, but the present invention is not at all restricted by such examples.

### Example 1

Aluminum oxide composite particles were prepared by a following sol-gel process, utilizing triisopropoxy aluminum as the metal alkoxide.

In 150 mL of toluene, 50 g of triisopropoxy aluminum were added and the mixture was agitated for 30 minutes at the room temperature (25° C.) to dissolve triisopropoxy aluminum.

In this solution, 5 g of zirconia (particle size: 1 μm) and 25 g of barium sulfate (particle size: 10 μm) as the inorganic particles, and 5 g of potassium titanate fibers (average diameter: 0.4 μm, average length: 15 μm) as the fibrous substance were added, and the mixture was agitated at the room temperature for 1 hour to obtain a mixed liquid. In this operation, an ultrasonic treatment may be added according to the necessity.

After 400 mL of ethanol and 10 mL of distilled water were added to the mixed liquid, the mixed liquid was agitated at 70° C. for 12 hours to execute hydrolysis and condensation of triisopropoxy aluminum, thereby obtaining an aluminum oxide sol. The sol formation may be executed by utilizing, if necessary, an acid catalyst such as acetic acid or a basic catalyst such as ammonia water.

Then the aluminum oxide sol was dried under vacuum at 110° C. to remove water and solvent, thereby obtaining 51 g of a dry gel. The dry gel was crushed in a mortar, and fine particles and coarse particles were removed by a classification method to obtain a crushed gel.

The crushed gel was subjected to a sintering process at a temperature of 400° C. for 2 hours to obtain 47 g of aluminum oxide composite particles having an average particle size of 200 μm.

An observation of the obtained aluminum oxide composite particle under a scanning electron microscope (SEM) proved that zirconia, barium sulfate and potassium titanate fibers were uniformly dispersed in the aluminum oxide, obtained by the sol-gel reaction of triisopropoxy aluminum.

### Example 2

Titanium oxide composite particles were prepared by a following sol-gel process, utilizing tetraisopropoxy titanium as the metal alkoxide.

In 300 mL of ethanol, 50 g of tetraisopropoxy titanium were added and the mixture was agitated for 30 minutes at the room temperature (25° C.) to dissolve tetraisopropoxy titanium.

In this solution, 5 g of zirconia (particle size: 1 μm), 25 g of barium sulfate (particle size: 10 μm) and 6 g of graphite (particle size: 35 μm) as the inorganic particles, together with 2 g of phenolic resin, were added, and the mixture was agitated at the room temperature for 1 hour to obtain a mixed liquid. In this operation, an ultrasonic treatment may be added according to the necessity.

After 50 mL of distilled water were added to the mixed liquid, the mixed liquid was agitated at 70° C. for 12 hours to execute hydrolysis and condensation of tetraisopropoxy titanium, thereby obtaining a titanium oxide sol. The sol formation may be executed by utilizing, if necessary, an acid catalyst such as acetic acid or a basic catalyst such as ammonia water.

Then the titanium oxide sol was dried under vacuum at 110° C. to remove water and solvent, thereby obtaining 62 g of a dry gel. The dry gel was crushed in a mortar, and fine particles and coarse particles were removed by a classification method to obtain a crushed gel.

The crushed gel was subjected to a sintering process at a temperature of 400° C. for 2 hours to obtain 55 g of titanium oxide composite particles having an average particle size of 110 μm.

An observation of the obtained titanium oxide composite particle under a scanning electron microscope (SEM) proved that zirconia, barium sulfate and graphite were uniformly dispersed in the titanium oxide, obtained by the sol-gel reaction of tetraisopropoxy titanium.

### Example 33

Silicon oxide composite particles were prepared by a following sol-gel process, utilizing tetraethoxysilane as the metal alkoxide.

In 300 mL of ethanol, 50 g of tetraethoxysilane were added and the mixture was agitated for 30 minutes at the room temperature (25° C.) to dissolve tetraethoxysilane.

In this solution, 5 g of calcium carbonate (particle size: 3 μm), 10 g of barium sulfate (particle size: 10 μm) and 2 g of copper powder (particle size: 50 μm) as the inorganic particles, and 10 g of rubber powder (particle size: 15 μm) as organic particles were added together with 2 g of phenolic resin, and the mixture was agitated at the room temperature for 1 hour to obtain a mixed liquid. In this operation, an ultrasonic treatment may be added according to the necessity.

After 50 mL of distilled water were added to the mixed liquid, the mixed liquid was agitated at 80° C. for 12 hours to execute hydrolysis and condensation of tetraethoxysilane, thereby obtaining a silicon oxide sol. The sol formation may be executed by utilizing, if necessary, an acid catalyst such as acetic acid or a basic catalyst such as ammonia water.

Then the silicon oxide sol was dried under vacuum at 110° C. to remove water and solvent, thereby obtaining 52 g of a dry gel. The dry gel was crushed in a mortar, and fine particles and coarse particles were removed by a classification method to obtain a crushed gel.

The crushed gel was subjected to a sintering process at a temperature of 300° C. for 2 hours to obtain 45 q of silicon oxide composite particles having an average particle size of 220 μm.

An observation of the obtained silicon oxide composite particle under a scanning electron microscope (SEM) proved that calcium carbonate, barium sulfate, copper powder and rubber powder were uniformly dispersed in the silane oxide, obtained by the sol-gel reaction of tetraethoxysilane.

### Example 4

In 100 parts by mass of a novolac phenolic resin powder (trade name PR-51794, manufactured by Sumitomo Bakelite Co., containing a curing agent) as a matrix material, 300 parts by mass of the aluminum oxide composite particles obtained in Example 1 were added and blended with a Henschel mixer to obtain a material for a friction material.

A friction material was prepared by pre-molding the aforementioned material for friction material at the normal temperature and under a pressure of 10 MPa, followed by curing at 150° C. and under a pressure of 30 MPa.

An observation of the obtained friction material under a scanning electron microscope (SEM) proved that the metal oxide composite particles were uniformly dispersed in the phenolic resin constituting the matrix material.

It will be apparent to those skilled in the art that various modifications and variations can be made to the described exemplary embodiment and the examples of the present invention without departing from the spirit or scope of the invention. Thus, it is intended that the present invention cover all modifications and variations of this invention consistent with the scope of the appended claims and their equivalents.

What is claimed is:

1. A producing method of a metal oxide composite particle, the producing method comprising:
forming a metal oxide sol by hydrolyzing and condensing a hydrolysable metal compound in a solvent and in a presence of an inorganic particle and/or an organic particle, and
drying, heating and crushing the metal oxide sol.

2. The producing method according to claim 1, wherein the inorganic particle comprises at least a material selected from barium sulfate, calcium carbonate, montmorillonite, mica, vermiculite, graphite, molybdenum disulfide, zirconia, alumina, silica, magnesium oxide, iron oxide, copper, aluminum, zinc, brass, and cast iron.

3. The producing method according to claim 1, wherein the organic particle comprises at least a material selected from phenolic resin, polyimide resin, polybenzoxazine resin, epoxy resin, aramide resin, fluorine-containing resin, rubber powder, and cashew powder.

4. The producing method according to claim 1, wherein the hydrolysable metal compound comprises a metal alkoxide.

5. The producing method according to claim 4, wherein a metal constituting the metal alkoxide comprises at least one selected from Al, Si, Ti and Zr.

6. The producing method according to claim 4, wherein the metal alkoxide is represented by a formula (I):
M(OR)ₙ (I)
wherein M represents Al, Si, Ti or Zr; R represents an alkyl group having 1 to 6 carbon atoms; and n is a valence number of M and represents 3 or 4.

7. The producing method according to claim 1, wherein an acidic catalyst or a basic catalyst is used at the hydrolysis and condensation of the hydrolysable metal compound for forming the metal oxide sol.

8. The producing method according to claim 1, wherein the drying is executed by drying in vacuum.

9. The producing method according to claim 1, wherein the heating is executed within a temperature range of from 200 to 1000° C.

10. The producing method according to claim 1, wherein the metal oxide composite particles have an average particle size of from 5 μm to 5 mm.

11. A metal oxide composite particle produced by the method according to claim 1.

12. A friction material comprising the metal oxide composite particle according to claim 11.
